(19) United States
(12) Patent Application Publication
(10) Pub. No.: US 2023/0380463 A1
(43) Pub. Date: Nov. 30, 2023

(54) SUGAR SUBSTITUTE

(71) Applicant: LongRun P.B.C., Belmont, MA (US)

(72) Inventors: Richard Theodore Tieken, Belmont, MA (US); Jennifer Shelley, Bellingham, MA (US)

(21) Appl. No.: 18/130,730

(22) Filed: Apr. 4, 2023

Related U.S. Application Data
(63) Continuation of application No. 17/081,688, filed on Oct. 27, 2020, now abandoned.
(60) Provisional application No. 62/926,718, filed on Oct. 28, 2019.

(51) Int. Cl. A23L 27/30; A23L 27/00; A23L 33/22; A23L 33/105

(52) U.S. Cl. CPC A23L 27/34; A23L 27/88; A23L 33/22; A23L 33/105; A23V 2002/00

(57) ABSTRACT

A ketogenic sweetener made from a combination of high intensity sweetener, medium intensity sweetener and soluble fiber. The process of making the ketogenic sweetener involves mixing the high intensity sweetener, medium intensity sweetener and soluble fiber at specific proportion to yield a homogenous composition. The ketogenic sweetener is ideal for diabetic individuals and people following ketogenic diets. The compositions of the invention are made from natural ingredients and have unique heat stable properties with low glycemic index and function as a prebiotic.

### CROSS-REFERENCE TO RELATED APPLICATION(S)

This patent application is a continuation of U.S. patent application Ser. No. 17/081,688 entitled SUGAR SUBSTITUTE filed Oct. 27, 2020, which claims the benefit of U.S. Provisional Patent Application No. 62/926,718 entitled SUGAR SUBSTITUTE filed Oct. 28, 2019, each of which is hereby incorporated by reference in its entirety.

### STATEMENT REGARDING FEDERALLY SPONSORED RESEARCH

Not applicable.

### STATEMENT REGARDING PRIOR DISCLOSURES BY THE INVENTOR OR A JOINT INVENTOR UNDER 37 C.F.R. 1.77(b)(6)

A product containing a sugar substitute of the type described below under Example 1: Preparation of Sweetener-I was first offered for sale to the public on Nov. 22, 2018 through the website www.ketoand.co as Keto and Co Keto Fudge Brownie Mix and was first shipped to customers on Dec. 14, 2018. Pursuant to the guidance of 78 Fed. Reg. 11076 (Feb. 14, 2013), Applicant is identifying this disclosure in the specification in lieu of filing a declaration under 37 C.F.R. 1.130(a). Applicant believes that such disclosure is subject to the exceptions of 35 U.S.C. 102(b)(1)(A) or 35 U.S.C. 102(b)(2)(a) as having been made or having originated from one or more members of the inventive entity of the application under examination.

### FIELD OF THE INVENTION

The invention generally relates to various sugar substitute compositions that are low-calorie sugar replacements for use in baking, cooking, and general sweetening of foods and beverages.

### BACKGROUND

Sugar is the generic name for sweet-tasting, soluble carbohydrates, many of which are used in food. “Table sugar” or “Common sugar” or “Refined sugar” refers to sucrose, a disaccharide of glucose and fructose. Sucrose is concentrated in sugarcane and sugar beet, making them ideal for efficient commercial extraction to make refined sugar. Common sugar has been used for centuries for adding to foods to sweeten them. Sucrose undergoes hydrolysis in the body and yields two monosaccharide molecules, glucose and fructose.

The use of low-calorie sweeteners, such as intense or potent sweeteners, as a replacement for table sugar in a variety of food products, has become common place in food and beverage formulations. For many consumers, however, products marketed as diet or light versions of products that are artificially sweetened are not preferred. Furthermore, the sugar substitutes that are currently on the market have unsatisfactory, look, feel and taste characteristics. Attempts have been made over the years to improve the taste delivery of these diet or light products and sugar substitutes. Besides sweetness, other health related and sensory characteristics of a food or beverage product, including the healthiness for a human being, effect on diabetics, flavor, mouthfeel, moisture content, and aftertaste of the product, affect the desirability of an artificial sweetener.

Low-calorie potent sweeteners permit the development of diet or light products through an ability to elicit sufficient sweetness at a very low concentration of the sweetener, but they are generally unable to mimic other sensory characteristics of sucrose, particularly density, taste, mouthfeel, and body. In many applications and recipes, sugar provides additional functionality besides the property of sweetness. Sugars interact with molecules of protein or starch during the baking and cooking process; act as a tenderizer by absorbing water and inhibit flour gluten development by delaying starch gelatinization; incorporate air into shortening in the creaming process; caramelize under heat to provide cooked and baked foods with a pleasing flavor, color and aroma; accelerate of the growth of yeast by providing food source; act as a whipping aid to stabilize beaten egg foams; delay the coagulation of egg proteins in custards; regulate the gelling of fruit jellies and preserves; help to prevent spoilage of jellies and preserves; improve the appearance and tenderness of canned fruits; delay discoloration of the surface of frozen fresh fruits; and enhance the smoothness and flavor of ice cream. It has been difficult to obtain a sugar replacement that has low calories but can also perform the same or similar functions of sugar in food recipes.

Thus, there is a need for sugar replacements that are low in calories, perform the same or similar functions of sugar in addition to sweetness.

### SUMMARY OF VARIOUS EMBODIMENTS

The invention aims to provide compositions comprising sugar replacements that have sweetness, taste, texture, mouthfeel, visual appearance and functionality like that of common sugar yet low in calories and can serve as a weight and/or volume equivalent replacement of common sugar in baking recipes, bakery products, and dietary products. Sugar replacements of the invention can act as weight and/or volume equivalent replacement of common sugar in recipes so that the beyond adding water in some embodiments end user doesn't have to alter the recipe in terms of amounts of ingredients being added or change the time or temperature of baking to get the same or similar desired end product as one would have gotten if they had used common sugar. In addition, the sugar replacements have prebiotic properties and serve as a healthier option than the common sugar to everyone including those with diabetics and people who follow ketogenic diets.

A ketogenic sweetener composition comprising one or more medium intensity sweetener, one or more high intensity sweetener, and one or more soluble fiber. The composition further comprising one or more flavor modifier. The composition wherein the at least one sugar alcohol includes at least one of mannitol, sorbitol, xylitol, lactitol, isomalt, erythritol, maltitol, or hydrogenated starch hydrolysates (HSH). The composition wherein the at least one rare sugar includes at least one of allulose, allose, psicose, tagatose, or melezitose. The composition wherein the flavor modifier is selected from the group consisting of vanilla extract, cinnamon extract, and bitter blocker. The composition wherein the medium intensity sweetener is between mass percent of the composition. The composition wherein the high intensity sweetener is between 0.1-0.5% mass percent of the composition. The composition wherein the soluble fiber consists of digestion resistant maltodextrin and inulin. The composition wherein the medium intensity sweetener is erythritol. The composition wherein the high intensity sweetener is monk fruit extract. The composition wherein the sugar alcohols comprise at least one of mannitol, sorbitol, xylitol, lactitol, isomalt, erythritol, maltitol, or hydrogenated starch hydrolysates (HSH) and the rare sugars comprise at least one of allulose, allose, psicose, tagatose, or melezitose.

Any one of the compositions above, wherein the one or more medium intensity sweetener includes at least one sugar alcohol and/or at least one rare sugar. Any one of the compositions above, wherein the one or more high intensity sweetener includes at least one of monk fruit extract, stevia extract, sucralose, neotame, aspartame, advantame, thaumatin, or acesulfame potassium. Any one of the compositions above, wherein the one or more soluble fiber includes at least one of soluble corn fiber, soluble tapioca fiber, digestion resistant dextrin, digestion resistant maltodextrin, Fibersol-2 binder or soluble corn fiber or soluble tapioca, inulin, chicory root extract, polydextrose, fructo-oligosaccharide, isomalto-oligosaccharide, galacto-oligosaccharide, or xylo-oligosaccharide.

Any one of the compositions above, wherein the soluble fiber is at an amount that is equal to or greater than the amount of medium intensity sweetener. Any one of the compositions above, wherein the ketogenic sugar replacement has a taste, texture, mouth feel and visual appearance of common sugar, and is capable of serving as a weight and/or volume equivalent replacement of common sugar in baking recipes, bakery products and dietary food products. Any one of the compositions above, wherein the high intensity sweetener comprises at least two of monk fruit extract, stevia extract, sucralose, neotame, aspartame, advantame, thaumatin or acesulfame potassium.

Any one of the compositions above, wherein the soluble fiber comprises at least two of soluble corn fiber, soluble tapioca fiber, digestion resistant dextrin, digestion resistant maltodextrin, Fibersol-2 binder, inulin, chicory root extract, polydextrose, fructo-oligosaccharide, isomalto-oligosaccharide, galacto-oligosaccharide, or xylo-oligosaccharide.

Any one of the compositions above, wherein the medium intensity sweetener and the soluble fiber are present at a weight ratio of 1:1. Any one of the compositions above, wherein the medium intensity sweetener is less than 50% mass percent of the composition. Any one of the compositions above, wherein the soluble fiber is greater than 50% mass percent of the composition. Any one of the compositions above, wherein the high intensity sweetener is less than 0.5% mass percent of the composition. Any one of the compositions above, wherein the soluble fiber is between 50-55% mass percent of the composition. Any one of the compositions above, wherein the percentage of medium intensity sweetener to the percentage of the soluble fiber is selected from the group consisting of 20/80, 25/75, 30/70, 40/60, 55/45, 50/50, and 45/55.

A method of producing anyone of the compositions above, wherein the amount of soluble fiber is adjusted to ensure good digestive tolerance, low glycemic index with a taste profile similar to those of raw sugar.

Additional embodiments may be disclosed and claimed.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a flowchart of the main steps of a process for making an enhanced sweetener according to an embodiment of the invention.

FIG. 2 shows a schematic representation showing concomitant matrices of various properties of the mixture being optimized to develop ketogenic sweeteners.

It should be noted that the foregoing figures and the elements depicted therein are not necessarily drawn to consistent scale or to any scale. Unless the context otherwise suggests, like elements are indicated by like numerals.

### DESCRIPTION OF ILLUSTRATIVE EMBODIMENTS

It is to be understood by those of ordinary skill in the art that the present discussion is a description of exemplary embodiments only and is not intended as limiting the broader aspects of the present invention.

The present invention generally pertains to sugar replacer compositions that are expected to replicate the flavor and cooking properties of sugar at very high levels so as to be useful as a sugar replacement generally and particularly for baking and cooking food products. The ketogenic sweeteners of the invention are made by mixing specific proportions of high intensity sweetener(s), medium intensity sweetener(s), and soluble fiber(s), typically to or substantially to homogeneity. Certain embodiments may use water or other solvents followed by heat or time to aid in the homogenous distribution of ingredients. Certain embodiments comprise a syrup of water or commercially available solvent such as alcohol or propylene glycol and one or more of medium intensity sweetener, flavor modifier, high intensity sweetener, or soluble fiber. Specifically, exemplary embodiments include at least one medium intensity sweetener acting as a large molecule base (e.g., sugar alcohols such as Erythritol or rare sugars such as Allulose), at least one soluble fiber (e.g., soluble corn fiber, soluble tapioca fiber, resistant maltodextrin, resistant dextrin, oligosaccharides, inulin, chicory root extract, etc.), and at least one high intensity sweetener (e.g., monk fruit extract). Without limitation, it is expected that the medium intensity sweetener(s) will impart “mouth feel” and structure to the finished product while participating in the sweetener matrix, the soluble fiber(s) will impart healthfulness and food properties like humectancy and caramelization while also participating in the sweetener matrix as a low intensity sweetener at a low or negligible level that helps significantly in improving the “cleanliness” of the sweetener blend, and the high intensity sweetener(s) will raise both the level and the “cleanliness” of sweetness to a level that is substantially equal to that of sugar both by weight and by volume. Certain exemplary embodiments additionally include one or more flavor modifiers (e.g., a “bitter blocker” to clean up the sweetness level by preventing the high intensity sweetener(s) from binding to non-sweet taste receptors on the tongue, or a flavor or fragrance that connotes sweetness in the human mind, e.g., vanilla, mild cinnamon, etc.). It is expected that exemplary embodiments will not significantly raise blood sugar levels and may have digestive benefits due to the included fiber. Embodiments can be made with all natural and non-GMO ingredients.

Preferably in some embodiments, erythritol is used as the medium intensity sweetener, monk fruit extract is used as the high intensity sweetener and digestion resistant maltodextrin along with inulin is used as the soluble fiber component. In other embodiments, allulose is used as the medium intensity sweetener, monk fruit extract is used as the high intensity sweetener and digestion resistant maltodextrin is used as the soluble fiber component. The sweetener compositions thus prepared have prebiotic properties and are heat stable to high temperatures such as 350° F. Surprisingly the sweeteners of the invention have similar taste, texture, mouthfeel, sweetness, and visual appearance as that of the common sugar.

The ability of the sweeteners to closely mimic the functional properties of common sugar during cooking and baking has enabled the sweeteners of the invention to serve as a weight and/or volume equivalent substitute of sugars in recipes. Sugar replacements of the invention therefore save time for the end users interested in producing low glycemic food products as they don't have to alter the recipe in terms of amounts of ingredients being added or change the time or temperature of baking to get the same or similar desired product as one would have gotten if they had just used common sugar. In addition, the sugar replacements have large amounts of soluble fiber and serve as a healthier option than common sugar for diabetics and others who follow ketogenic diets.

### Definitions

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, illustrative methods and materials are described. As used herein, each of the following terms has the meaning associated with it in this section.

The articles “a” and “an” are used herein to refer to one or more than one (i.e., to at least one) of the grammatical object of the article. By way of example, “an element” means one element or more than one element.

As defined herein, the term “ketogenic sweetener” or “sugar replacement” or “sugar substitute”, used interchangeably, refers to a food additive or an ingredient that provides a sweet taste like that of sugar while containing significantly fewer calories ideal for everyone who prefer healthier food choices including diabetic patients or people who follow a low carbohydrate intake diet such as a keto diet.

As defined herein, the term “medium intensity sweetener” is an ingredient that is capable of serving as the base matrix in which high intensity sweeteners and soluble fibers are mixed together. Medium intensity sweeteners contribute to taste, texture, mouthfeel, visual appearance and functionality of the ketogenic sweeteners. Examples include mannitol, sorbitol, xylitol, lactitol, isomalt, erythritol (granulated or powder form or liquid), maltitol, hydrogenated starch hydrolysates (HSH), allulose, allose, allulose (granulated or powder or liquid form), glycerin (liquid), psicose, tagatose and melezitose.

As defined herein, the term “high intensity sweetener” refers to an ingredient that is many times sweeter than sugar but contribute only a few to no calories when added to foods. Such high intensity sweeteners may be 50-2,000 times sweeter than sugar. Examples include stevia extract, monk fruit extract, Reb M Stevia Glycoside (Sweet Essence M 350×), sucralose, neotame, aspartame, advantame and acesulfame potassium, thaumatin, etc. High potency sweeteners are chemically different from sugars and are not classified as sugars. They may be natural or artificial.

As defined herein, the term “soluble fiber” refers to an edible fiber component that is soluble in water. When mixed with water it forms a gel-like substance and swells. Soluble fiber has many benefits, including prebiotic, moderating blood glucose levels and lowering cholesterol. Examples include soluble corn fiber or soluble tapioca fiber or digestion resistant dextrin, soluble corn fiber powder, Psyllium Husk (95% grade), liquid corn fiber, agar agar, pectin, Guar gum, Xanthum gum, digestion resistant maltodextrin, inulin or chicory root extract, polydextrose, fructo-oligosaccharide, isomalto-oligosaccharide, galacto-oligosaccharide, xylo-oligosaccharide.

As defined herein, the term “flavor modifiers” refer to ingredients that when used in conjunction with other sweeteners enhances the flavor profile and reduces the bitter aftertaste of sweeteners without significantly increasing the calorie content of the sweetener. Examples include vanilla extract, cinnamon extract, mint extract, eriodictyol, ferulic acid, homoeriodictyol, sodium ferulate, and sterubin.

As defined herein, the term “sugar alcohols” refer to organic compounds, typically derived from sugars, containing one hydroxyl group (—OH) attached to each carbon atom. They are generally white, water-soluble solids that can occur naturally or produced industrially by hydrogenation of sugars. Sugar alcohols are used widely in the food industry as thickeners and sweeteners. Examples include mannitol, sorbitol, xylitol, lactitol, isomalt, erythritol, maltitol, and hydrogenated starch hydrolysates (HSH).

As defined herein, the term “rare sugars” refer to monosaccharides and their derivatives that seldom occur in nature. Typically, rare sugars are made through biological processes such as fermentation or enzyme conversion to create the identical compound as found in nature. Examples include D-Psicose, D-Tagatose, D-Allose, D-Ribose, and melezitose.

As defined herein, the term “common sugars” refer to table sugar or sucrose, which is the sugar most commonly used as a food ingredient. Other sugars include maltose, lactose and other disaccharides, as well as monosaccharides such as glucose or dextrose, fructose, and galactose.

As defined herein, the term “mass percent” refers to a way of representing the concentration of an element in a compound or a component in a mixture. Mass percentage is calculated as the mass of a component divided by the total mass of the mixture, multiplied by 100. (w/w %)

As defined herein, the term “weight and/or volume equivalent replacement” refers to the ability of a sweetener to replace sugar from any recipe and yield the desired final food product without requiring changes to the recipe such as changing the amounts of ingredients or temperature or time of baking. For example, ketogenic sweeteners of the invention can be used as either “cup for cup” or “pound for pound” replacement of sugar, meaning if the recipe for baking or cooking a food product calls for using one cup of sugar, the end user can use one cup of the ketogenic sweetener instead and still be able to follow the recipe without making changes to amounts of other ingredients, cooking time or temperature to produce the end product with same or similar flavor and texture profile as one would have obtained if sugar was used.

As defined herein, the term “taste” refers to sensation obtained from a substance in the mouth that is typically produced by the stimulation of the sense of taste combined with those of touch and smell.

As defined herein, the term “texture” refers to the tactile surface characteristics of a substance such as sugar.

As defined herein, the term “mouthfeel” refers to the physical sensations in the mouth caused by food or drink, as distinct from taste. It is a fundamental sensory attribute which, along with taste and smell, determines the overall flavor of a food item.

As defined herein, the term “visual appearance” refers to the positive visual sensations experienced by the consumer when a product is viewed on the shelf, as it is being prepared and when it is presented on the plate for consumption.

As defined herein the term “moisture content” refers to the amount of water present in the end product made using sugar replacements of the invention. Moisture content is determined by measuring the weight of the food sample before and after drying in an oven, allowing a percent moisture to be calculated.

As defined herein the term “plasticity or bendability” refers to the ability of the end product made from the sugar replacements to be spread and shaped

As defined herein the term “shininess or glossiness” refers to the ability of the end product made from the sugar replacements to reflect light thereby creating an appetizing visual perception.

As used herein the term “digestive tolerance” refers to the ability of the consumer to be able tolerate various amounts of various ingredients in the sugar replacement formulations without experiencing digestive discomfort characterized by one or more of abdominal pain, rumbling, bloating and flatulence. In general, little or no symptoms of digestive discomfort after consumption of end product indicate that the ingredient and their amounts in sugar formulations are optimal.

“About” as used herein when referring to a measurable value such as an amount, a temporal duration, and the like, is meant to encompass variations of ±20% or ±10%, in certain embodiments ±5%, in certain embodiments ±1%, in certain embodiments ±0.1% from the specified value, as such variations are appropriate to perform the disclosed methods.

Ranges: throughout this disclosure, various aspects according to the invention can be presented in a range format. The description in range format is merely for convenience and brevity and should not be construed as an inflexible limitation on the scope according to the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

References herein to “digestion resistant dextrin” can include one or more cyclodextrins, which are a family of cyclic oligosaccharides generally produced from starch by enzymatic conversion.

It should be noted that any references herein to a product by trade name is intended to include at least the corresponding generic product/name currently associated with the trade name and equivalent and similar products.

### Examples

Unless otherwise noted, all components such as medium intensity sweetener, high intensity sweetener and soluble fiber are procured from commercial sources. Medium intensity sweeteners such as erythritol were obtained from Cargill (Harrisburg, Texas, US), and allulose were obtained from Tate and Lyle (Dayton, Ohio, USA). High intensity sweetener such as monk fruit extract was obtained from Tate and Lyle. Soluble fiber components such as soluble tapioca, soluble corn fiber, digestion resistant maltodextrin was obtained from ADM and inulin was obtained from Cargill. All components were weighed using OHAUS Adventurer analytical balances to ensure accuracy. In some embodiments, solid forms or powder versions of medium intensity sweetener, high intensity sweetener and soluble fiber were mixed with water to prepare sugar replacement compositions. In some embodiments, liquid forms or syrup versions of medium intensity sweetener, high intensity sweetener and soluble fiber were mixed together to prepare sugar replacement compositions. Generally, aforesaid syrups were made by dissolving one or more ingredients such as medium intensity sweetener, high intensity sweetener and soluble fiber in commercial solvents such as water, alcohol or propylene glycol.

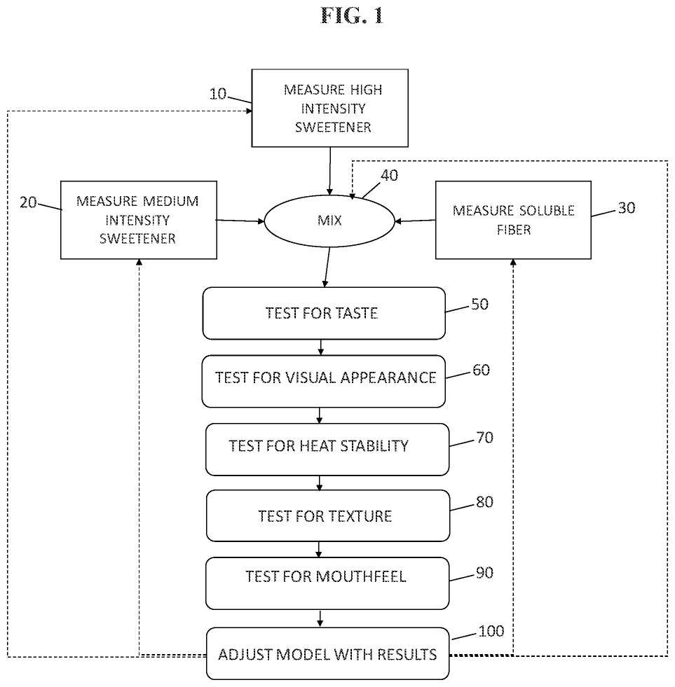

The amount of each component used can be varied to better optimize the functional aspects such as taste, texture, heat stability, mouthfeel etc. to closely mimic that of the common sugar. FIG. 1 illustrates the schematic of the process of making the ketogenic sweetener. The weighed components such as medium intensity sweetener(s) (as in step 20), high intensity sweetener(s) (as in step 10), and soluble fiber component(s) (as in step 30) are then mixed (as in step 40) together at specific proportions. The resultant composition is mixed thoroughly, e.g., using a commercial mixer such as a fluidizing paddle blender, double or single ribbon blender, tumble blender, v blender, including any of the former with a liquid spray system, to ensure that the ketogenic sweetener produced has a homogenous or substantially homogenous dispersion of all ingredients. Optionally, flavor modifier can be added at the mixing stage (as in step 40) in trace amounts, greater than 0% but less than 2%, for example, at 0.005 to 0.01% (w/w %) of the total weight of the composition.

The sugar substitute thus prepared then can be analyzed for taste (as in step 50), visual appearance (as in step 60), heat stability (as in step 70), texture (as in step 80), and mouth feel (as in step 90). For example, the composition can be tested by baking into food products such as cookies and cakes to determine sweetness, taste profile, heat stability, mouthfeel, visual appearance, plasticity, and texture using standardized protocols. Sample brownies were made using sugar replacement formulations that contain various amounts of ingredients. The brownies containing different sugar replacement compositions were then sampled were a panel of two. The first panel evaluated the brownies on taste, texture, sweetness, bendability or plasticity of the brownie, light reflection indicating the formation of fudge and lack of crystallization in the interior of the brownie. The sugar replacement compositions selected by the first panel were then used to make a second batch of cookies and were then blind tasted by a second panel of at least five people. The evaluation criteria employed by the second panel included (a) Visual attributes-presence or absence of visible crystals or other defects in the final product, (b) Light reflection properties or Shininess—degree of reflection of light evidencing a fudge formation, (c) Texture and sweetness via organoleptic sampling with focused questioning around “roundness of the sweet,” “duration of the sweet,” “presence of unexpected flavor notes” and “bitter side effects”, (d) Heat Stability—whether the sugar replacements in the brownie batter were able to withstand high temperatures and avoid degradation. The presence of unexpected flavor notes or bitterness indicated that the sweetener composition had degraded under heat, or there is cross binding of the sweeteners with bitter receptors in the tongue, and (e) Digestive tolerance—whether there was a feeling of fullness or unease after 30- and 90-minutes post-consumption of brownie samples.

Heat stability of sample brownies were cross referenced with available reference materials (See African Journal of Food Science Vol. 4(5) pp. 269-281, May 2010; tateandlyle.com/ingredient/purefruit-monk-fruit-extract dated Oct. 24, 2019; Rev Inves Clin. 2017; 69:129-38; L 'Obrien Nabors, G E Inglett, A review of various other alternative sweeteners: In: L O'Broen Nabors, R C Gelardi, eds. Alternative Sweetners, New York: Marcel Dekker, 1986, pp 309-323; and A D Kinghorn, C M Compadre, Less common sweeteners. I: L. Obrien Wabors, R C Gelardi, eds. Alternative Sweeteners, 2^{nd} Ed., Revised and Expanded, New York: Marcel Dekker, 1991, pp 151-171 and 212). Final sugar replacement formulations that were selected after the second tasting panel underwent blood sugar and ketone testing for blood sugar using ketone meters (Keto Mojo company) at 30 and 90 minutes after consumption to confirm the glycemic effect. The formulations that did not greatly spike the blood sugar levels following the blood-sugar tests were then used with recipes from the internet that were randomly selected from the first 3 results on google for cookies, cake, and cheesecake to confirm water addition requirements. The cookies, cake, and cheesecake made from the selected sugar replacement formulations were then taste tested by a third tasting panel of at least five people to ensure that the selected formulations perform well in all types of recipes.

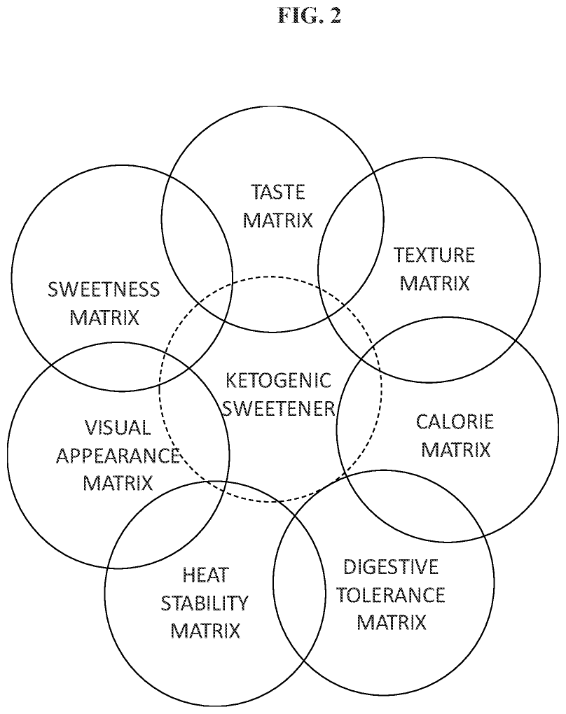

Optionally additional properties such as viscosity, crystallinity, tackiness, and gelling properties of the sweetener can also be analyzed using standardized protocols known in food science. FIG. 2 illustrates the optimization matrix representing desired properties and the ketogenic sweetener composition that mimics the functional properties of common sugar. The optimization is carried out by iteration (as in step 100) by varying the amounts of components, mixing the components and performing the tests to determine whether the specific proportion of components when mixed together yield a ketogenic sweetener with desired properties that mimic those of the common sugar.

### Example 1

### Preparation of Sweetener-I

Sugar substitute compositions can be prepared by mixing approximately 40-55% (w/w %) of medium intensity sweetener with approximately 40-55% (w/w %) of soluble fiber along with approximately 0.1-1% (w/w %) high intensity sweetener. For example, compositions may include around 47-50% (w/w %) of medium intensity sweetener mixed with around 49-51% (w/w %) soluble fiber and around 0.2-0.4% (w/w %) of high intensity sweetener. In some instances, the ratio of the amount of medium intensity sweetener to the amount of soluble fiber can be approximately 1:1. Optionally, a flavor modifier such as clear extract mushroom based bitter blocker can be added to the composition, for example, at around 0.001-0.1% (w/w %) of the total weight of the composition.

One exemplary composition includes around 0.6 grams of monk fruit extract powder (approximately 0.4% of high intensity sweetener), around 74 grams of Erythritol (approximately 49.1% of medium intensity sweetener), around 72 grams of Fibersol-2 binder-soluble fiber component (approximately 47.8% of final composition); and around 4 grams of inulin (approximately 2.7% of final composition).

### Example 2

### Preparation of Sweetener-II

Sugar substitute compositions can be prepared by mixing 49-55% (w/w %) of medium intensity sweetener with 49-55% (w/w %) of soluble fiber along with 0.2-0.5% (w/w %) high intensity sweetener. For example, compositions may include around 49-50% (w/w %) of medium intensity sweetener mixed with around 49-51% (w/w %) soluble fiber and around 0.2-0.4% (w/w %) of high intensity sweetener. In some instances, the ratio of the amount of medium intensity sweetener to the amount of soluble fiber can be approximately 1:1. Optionally, a flavor modifier can be added to the composition, for example, at around 0.001-0.1% (w/w %) of the total weight of the composition.

One exemplary composition includes 0.6 grams of monk fruit powder (approximately 0.4%), 74 grams of Erythritol (approximately 49.5%), 75 grams of Fibersol-2 binder or soluble tapioca (approximately 50.1%).

### Example 3

### Preparation of Sweetener-III

Sugar substitute compositions can be prepared by mixing 40-55% (w/w %) of medium intensity sweetener with 40-55% (w/w %) of soluble fiber along with 0.1-0.5% (w/w %) high intensity sweetener. For example, compositions can include around 47-50% (w/w %) of medium intensity sweetener mixed with around 49-51% soluble fiber and around 0.2-0.4% (w/w %) of high intensity sweetener. In some instances, the ratio of the amount of medium intensity sweetener to the amount of soluble fiber can be approximately 1:1. Optionally, a flavor modifier can be added to the composition, for example, at around 0.001-0.1% (w/w %) of the total weight of the composition.

One exemplary composition includes 0.6 grams of monk fruit powder (approximately 0.4%), 74 grams of Allulose (approximately 49.1%), 72 grams of Fibersol-2 binder or soluble tapioca (approximately 47.8%), and 4 grams of inulin (approximately 2.7%).

### Example 4

### Preparation of Sweetener-IV

Sugar substitute compositions can be prepared by mixing 49-55% (w/w %) of medium intensity sweetener with 49-55% (w/w %) of soluble fiber along with 0.2-0.5% (w/w %) high intensity sweetener. For example, compositions can include around 49-50% (w/w %) of medium intensity sweetener mixed with around 49-51% (w/w %) of soluble fiber and around 0.2-0.4% (w/w %) of high intensity sweetener. In some instances, the ratio of the amount of medium intensity sweetener to the amount of soluble fiber can be approximately 1:1. Optionally, a flavor modifier can be added to the composition, for example, at around 0.001-0.1% (w/w %) of the total weight of the composition.

One exemplary composition includes 0.6 grams of monk fruit powder (approximately 0.4%), 74 grams of Allulose (approximately 49.4%), and 75 grams of Fibersol-2 binder or soluble tapioca (approximately 50.2%).

### Example 5

### Preparation of Sweetener-V

Sugar substitute compositions can be prepared by mixing 35-70% (w/w %) of medium intensity sweetener with 40-60% (w/w %) of soluble corn fiber or soluble tapioca along with 0.1-1% (w/w %) high intensity sweetener. For example, compositions may include one or more medium intensity sweeteners such as Allulose and erythritol mixed with around 40-60% (w/w %) soluble corn fiber or tapioca and around 0.2-0.4% (w/w %) of high intensity sweetener. Optionally, a flavor modifier can be added to the composition, for example, at around 0.001-(w/w %) of the total weight of the composition.

One exemplary composition includes 25-40% Allulose, 10-30% Erythritol, 40-60% soluble corn fiber or 40-60% soluble tapioca, and 0.1-1.0% monk fruit.

### Example 6

Preparation of Sweetener syrup

Sugar substitute compositions can be prepared by mixing 35-50% (w/w %) of medium intensity sweetener in syrup or liquid form with 40-60% (w/w %) of soluble corn fiber in syrup form along with 0.01-1% (w/w %) high intensity sweetener, mixed together in 0-15% edible solvent such as water, alcohol or propylene glycol.

For example, compositions may include medium intensity sweeteners such as Allulose syrup or erythritol mixed with around 40-60% (w/w %) soluble corn fiber syrup and around 0.1-1% (w/w %) of high intensity sweetener. Optionally, a flavor modifier can be added to the composition, for example, at around 0.001-0.1% (w/w %) of the total weight of the composition.

One exemplary composition includes 35-50% Allulose Syrup, 40-60% Soluble Corn Fiber Syrup, 0-15% Water, 0.1-1.0% monk fruit, and 0.01-1.0% natural flavors or flavor modifiers.

### Example 7

### Preparation of Sweetener-VI

The sweetener composition has favorable properties in frozen desert applications. Approximate formulation is as shown below:

| | | Grams | % |
|---|---|---|---|
| Medium Intensity | Allulose Granulated | 79 | 35% |
| Sweetener | | | |
| Medium Intensity | Erythritol Granulated | 44 | 19% |
| Sweetener | | | |
| Medium Intensity | Glycerin (liquid) | 12.44 | 5% |
| Sweetener | | | |
| Soluble Fiber | Soluble Corn Fiber Powder | 93 | 41% |
| High | Monkfruit (1.76 g liquid | 0.44 | 0.19% |
| Intensity | as 25% solution, | | |
| Sweetener | used to aid in dosing) | | |
| Total | | 228.88 | 100.0% |

The Sweetener formulation can be enhanced by performing optional modifications to the formulation such as addition of one or more flavor modifiers, addition of one or more soluble fibers, or using a different medium intensity sweetener. Some optional modifications include changes to the process of production such as time of addition of components or the temperature at which the component is added to the mixture. For example, some alternatives include adding vanilla extract as flavor modifier (e.g., 10 gm), adding salt as flavor modifier (e.g., 1.5 gm), adding both vanilla extract and salt as flavor modifiers, adding xanthan gum soluble fiber (e.g., 0.5 gm), adding guar gum soluble fiber (e.g., 0.5 gm), adding both xanthan and guar gum, adding locust bean gum soluble fiber (e.g., 0.5 gm), adding locust bean and guar gum, and using Sorbitol instead of Allulose.

### Example 8

### Preparation of Sweetener-VII

The sweetener composition has favorable properties in frozen desert application.

Approximate formulation:

| | | Grams | % |
|---|---|---|---|
| Medium Intensity | Allulose Granulated | 79 | 36% |
| Sweetener | | | |
| Medium Intensity | Erythritol Granulated | 44 | 20% |
| Sweetener | | | |
| Soluble Fiber | Soluble Corn Fiber Powder | 93 | 43% |
| High | Monk fruit (1.76 g liquid | 0.44 | 0.20% |
| Intensity | as 25% solution, | | |
| Sweetener | used to aid in dosing) | | |
| Total | | 216.44 | 100.0% |

The Sweetener formulation can be enhanced by performing optional modifications to the formulation and/or process of production as described in previous example 7. For example, some alternatives include adding vanilla extract as flavor modifier (e.g., 10 gm), adding salt as flavor modifier (e.g., 1.5 gm), adding both vanilla extract and salt as flavor modifiers, adding xanthan gum soluble fiber (e.g., 0.5 gm), adding guar gum soluble fiber (e.g., 0.5 gm), adding both xanthan and guar gum, adding locust bean gum soluble fiber (e.g., 0.5 gm), adding locust bean and guar gum, and using Sorbitol instead of Allulose.

### Example 9

### Preparation of Sweetener-VIII

The sweetener composition has favorable properties for producing caramel. The sweetener composition at room temperature is semi solid and is ideal for use in candies (e.g. gummies or caramel)

| | | Grams | % |
|---|---|---|---|
| Medium Intensity | Allulose Granulated | 377 | 77% |
| Sweetener | | | |
| Water | Water | 20 | 4% |
| Soluble Fiber | Soluble Corn Fiber Syrup | 90 | 18% |
| High Intensity | Monk fruit Powder | 0.25 | 0.05% |
| Sweetener | | | |
| Flavor Modifier | Vanilla (liquid extract) | 5 | 1.0% |
| Total | | 492.25 | 100.0% |

The Sweetener formulation can be enhanced by performing optional modifications to the formulation and/or process of production as described in previous example 7. For example, some alternatives include adding vanilla extract as flavor modifier (e.g., 5 g), adding salt as flavor modifier (e.g., 6 g), and adding vanilla extract and salt as flavor modifiers (e.g., 5 g and 6 g respectively). Preparation can include raising the temperature to 320 degrees over 5-10 minutes before immediately removing from heat and adding additional ingredients. For example, vanilla extract or other volatile flavors may be added after cooling to 200 degrees. Similarly, high intensity sweetener may be added after cooling below 200 degrees.

### Example 10

### Preparation of Sweetener-IX

The sweetener composition has favorable properties for producing chewy brownies. The sweetener composition imparts a favorable chewiness to end product.

Approximate formulation:

| | | Grams | % |
|---|---|---|---|
| Medium Intensity | Allulose Granulated | 100 | 47% |
| Sweetener | | | |
| Flavor Modifier | Salt | 3.3 | 2% |
| Soluble Fiber | Soluble Corn Fiber powder | 104.845 | 50% |
| High Intensity | Monk fruit Powder | 0.222 | 0.11% |
| Sweetener | | | |
| Flavor Modifier | Vanilla (as flavor powder) | 2.997 | 1% |
| Total | | 211.364 | 100.0% |

The Sweetener formulation can be enhanced by performing optional modifications to the formulation and/or process of production as described in previous example 7. For example, some alternatives include adding vanilla extract as flavor modifier (e.g., 2.9 g), adding salt as flavor modifier (e.g., 3.3 g), and adding vanilla extract and salt as flavor modifiers.

### Example 11

### Preparation of Sweetener-X

The sweetener composition has favorable properties for producing chewy brownies—The Sweetener composition uses a different high intensity sweetener.

Approximate formulation:

| | | Grams | % |
|---|---|---|---|
| Medium Intensity | Erythritol Granulated | 99.917 | 48% |
| Sweetener | | | |
| Soluble Fiber | Innulin | 4.996 | 2% |
| Soluble Fiber | Soluble Corn Fiber powder | 104.845 | 50% |
| High Intensity | Reb M Stevia Glycoside | 0.157 | 0.07% |
| Sweetener | (Sweet Essence M 350x) | | |
| Total | | 209.915 | 100.0% |

The Sweetener formulation can be enhanced by performing optional modifications to the formulation and/or process of production as described in previous example 7. Some alternatives include adding vanilla flavor powder as flavor modifier (e.g., 2.9 g), adding salt as flavor modifier (e.g., 3.3 g), and adding vanilla extract and salt as flavor modifiers.

### Example 12

### Preparation of Sweetener-XI

The sweetener composition has favorable properties for producing brownies—The sweetener composition uses a different high intensity sweetener

Approximate formulation:

| | | Grams | % |
|---|---|---|---|
| Medium Intensity | Erythritol Granulated | 49.9585 | 24% |
| Sweetener | | | |
| Medium Intensity | Allulose Granulated | 49.9585 | 24% |
| Sweetener | | | |
| Soluble Fiber | Innulin | 4.996 | 2% |
| Soluble Fiber | Soluble Corn Fiber powder | 104.845 | 50% |
| High Intensity | Reb M Stevia Glycoside | 0.157 | 0.07% |
| Sweetener | (Sweet Essence M 350x) | | |
| Total | | 209.915 | 100.0% |

The sweetener formulation can be enhanced by performing optional modifications to the formulation and/or process of production as described in previous example 7. Some alternatives include adding vanilla flavor powder as flavor modifier (e.g., 2.9 g), adding salt as flavor modifier (e.g., 3.3 g), and adding vanilla extract and salt as flavor modifiers.

### Example 13

### Preparation of Sweetener-XII

The sweetener composition has favorable properties for producing brownie. The sweetener composition uses a different high intensity sweetener

Approximate formulation:

| | | Grams | % |
|---|---|---|---|
| Medium Intensity | Erythritol Granulated | 99.917 | 48% |
| Sweetener | | | |
| Soluble Fiber | Soluble Corn Fiber powder | 109.841 | 52% |
| High Intensity | Reb M Stevia Glycoside | 0.157 | 0.07% |
| Sweetener | (Sweet Essence M 350x) | | |
| Total | | 209.915 | 100.0% |

The sweetener formulation can be enhanced by performing optional modifications to the formulation and/or process of production as described in previous example 7. For example, some alternatives include adding vanilla flavor powder as flavor modifier (e.g., 2.9 g), adding salt as flavor modifier (e.g., 3.3 g), and adding vanilla extract and salt as flavor modifiers.

### Example 14

### Preparation of Sweetener-XIII

The sweetener composition has favorable properties for producing brownies. The sweetener composition uses a different high intensity sweetener

Approximate formulation:

| | | Grams | % |
|---|---|---|---|
| Medium Intensity | Allulose Granulated | 100 | 48% |
| Sweetener | | | |
| Soluble Fiber | Soluble Corn Fiber powder | 109.841 | 52% |
| High Intensity | Reb M Stevia Glycoside | 0.157 | 0.07% |
| Sweetener | (Sweet Essence M 350x) | | |
| Total | | 209.998 | 100.0% |

The sweetener formulation can be enhanced by performing optional modifications to the formulation and/or process of production as described in previous example 7. For example, some alternatives include adding vanilla flavor powder as flavor modifier (e.g., 2.9 g), adding salt as flavor modifier (e.g., 3.3 g), and adding vanilla extract and salt as flavor modifiers.

### Example 15

### Preparation of Sweetener-XIV

The sweetener composition has favorable properties for producing brownies. The composition uses a different high intensity sweetener.

Approximate formulation:

| | | Grams | % |
|---|---|---|---|
| Medium Intensity | Erythritol Granulated | 99.92 | 48% |
| Sweetener | | | |
| Soluble Fiber | Innulin | 5 | 2% |
| Soluble Fiber | Soluble Corn Fiber powder | 104.85 | 50% |
| High Intensity | Thaumatin | 0.03 | 0.01% |
| Sweetener | | | |
| Total | | 209.8 | 100.0% |

The sweetener formulation can be enhanced by performing optional modifications to the formulation and/or process of production as described in previous example 7. For example, some alternatives include adding vanilla flavor powder as flavor modifier (e.g., 2.9 g), adding salt as flavor modifier (e.g., 3.3 g), and adding vanilla extract and salt as flavor modifiers.

### Example 16

### Preparation of Sweetener-XV

The sweetener composition has favorable properties for producing brownies. The sweetener composition uses a different high intensity sweetener.

Approximate formulation:

| | | Grams | % |
|---|---|---|---|
| Medium Intensity | Erythritol Granulated | 49.9585 | 24% |
| Sweetener | | | |
| Medium Intensity | Allulose Granulated | 49.9585 | 24% |
| Sweetener | | | |
| Soluble Fiber | Innulin | 5 | 2% |
| Soluble Fiber | Soluble Corn Fiber powder | 104.85 | 50% |
| High Intensity | Thaumatin | 0.03 | 0.01% |
| Sweetener | | | |
| Total | | 209.797 | 100.0% |

The sweetener formulation can be enhanced by performing optional modifications to the formulation and/or process of production as described in previous example 7. For example, some alternatives include adding vanilla flavor powder as flavor modifier (e.g., 2.9 g), adding salt as flavor modifier (e.g., 3.3 g), and adding vanilla extract and salt as flavor modifiers.

### Example 17

### Preparation of Sweetener-XVI

The sweetener composition has favorable properties for producing brownies. The sweetener composition uses a different high intensity sweetener.

Approximate formulation:

| | | Grams | % |
|---|---|---|---|
| Medium Intensity | Erythritol Granulated | 99.92 | 48% |
| Sweetener | | | |
| Soluble Fiber | Soluble Corn Fiber powder | 109.85 | 52% |
| High Intensity | Thaumatin | 0.03 | 0.01% |
| Sweetener | | | |
| Total | | 209.8 | 100.0% |

The sweetener formulation can be enhanced by performing optional modifications to the formulation and/or process of production as described in previous example 7. For example, some alternatives include adding vanilla flavor powder as flavor modifier (e.g., 2.9 g), adding salt as flavor modifier (e.g., 3.3 g), and adding vanilla extract and salt as flavor modifiers.

### Example 18

### Preparation of Sweetener-XVII

The sweetener composition has favorable properties for producing Macaroon “Peanuts”. The sweetener composition provides additional moisture trapping properties which allows the end product to retain moisture even after baking and is, thus favorable for producing moist bakery such as soft bake cookies

Approximate formulation:

| | | Grams | % |
|---|---|---|---|
| Medium Intensity | Erythritol Granulated | 48.314 | 47% |
| Sweetener | | | |
| Soluble Fiber | Psyllium Husk (95% grade) | 4.191 | 4% |
| Soluble Fiber | Soluble Corn Fiber powder or | 46.667 | 46% |
| | Soluble tapioca fiber powder | | |
| Soluble Fiber | Inulin | 2.435 | 2% |
| High Intensity | Monk fruit | 0.673 | 0.66% |
| Sweetener | | | |
| Total | | 102.28 | 100.0% |

The sweetener formulation can be enhanced by performing optional modifications to the formulation and/or process of production as described in previous example 7. For example, some alternatives include adding vanilla flavor powder as flavor modifier (e.g., 3.71 gm), adding salt as flavor modifier (e.g., 2.49 gm), and adding vanilla extract and salt as flavor modifiers.

### Example 19

### Preparation of Sweetener-XVIII

The sweetener composition has favorable properties for producing Macaroon Almond. The sweetener composition provides additional moisture trapping properties which allows the end product to retain moisture even after baking and is, thus favorable for producing moist bakery (e.g. soft bake cookie)

Approximate formulation:

| | | Grams | % |
|---|---|---|---|
| Medium Intensity | Erythritol Granulated | 48.43 | 47% |
| Sweetener | | | |
| Soluble Fiber | Xanthan Gum | 1.29 | 1% |
| Soluble Fiber | Psyllium Husk (95% grade) | 4.2 | 4% |
| Soluble Fiber | Soluble Corn Fiber powder or | 46.78 | 45% |
| | Soluble tapioca fiber powder | | |
| Soluble Fiber | Inulin | 2.44 | 2% |
| High Intensity | Monk fruit | 0.68 | 0.65% |
| Sweetener | | | |
| Total | | 103.82 | 100.0% |

The sweetener formulation can be enhanced by performing optional modifications to the formulation and/or process of production as described in previous example 7. For example, some alternatives include adding vanilla flavor powder as flavor modifier (e.g., 3.71 gm), adding salt as flavor modifier (e.g., 1.96 gm), and adding vanilla extract and salt as flavor modifiers.

### Example 20

### Preparation of Sweetener-XIX

The sweetener composition has favorable properties for producing Muffin Base. The sweetener composition has higher usage rate with less crystalline mouth feel.

Approximate formulation:

| | | Grams | % |
|---|---|---|---|
| Medium Intensity | Erythritol Granulated | 60.948 | 44% |
| Sweetener | | | |
| Medium Intensity | Allulose | 20.403 | 15% |
| Sweetener | | | |
| Soluble Fiber | Soluble Corn Fiber powder or | 56.107 | 41% |
| | Soluble tapioca fiber powder | | |
| High Intensity | Monk fruit | 0.181 | 0.13% |
| Sweetener | | | |
| Total | | 137.639 | 100.0% |

The sweetener formulation can be enhanced by performing optional modifications to the formulation and/or process of production as described in previous example 7. For example, some alternatives include adding vanilla flavor powder as flavor modifier (e.g., 3.826 gm), adding salt as flavor modifier (e.g., 3.149 gm), and adding vanilla extract and salt as flavor modifiers.

### Example 21

### Preparation of Sweetener-XX

The sweetener composition has favorable properties for producing Muffin Base. The sweetener composition has higher usage rate with less crystalline mouth feel.

Approximate formulation:

| | | Grams | % |
|---|---|---|---|
| Medium Intensity | Erythritol Granulated | 60.948 | 43% |
| Sweetener | | | |
| Medium Intensity | Allulose | 20.403 | 15% |
| Sweetener | | | |
| Soluble Fiber | Xanthan Gum | 1.326 | 1% |
| Soluble Fiber | Soluble Corn Fiber powder or | 56.107 | 40% |
| | Soluble tapioca fiber powder | | |
| Soluble Fiber | Guar Gum | 1.326 | 1% |
| High Intensity | Monk fruit | 0.181 | 0.13% |
| Sweetener | | | |
| Total | | 140.291 | 100.0% |

The sweetener formulation can be enhanced by performing optional modifications to the formulation and/or process of production as described in previous example 7. For example, some alternatives include adding vanilla flavor powder as flavor modifier (e.g., 3.826 gm), adding salt as flavor modifier (e.g., 3.149 gm), and adding vanilla extract and salt as flavor modifiers.

### Example 22

### Preparation of Sweetener-XXI

The sweetener composition has favorable properties for producing chocolate syrup. The sweetener composition has higher viscosity and is favorable for producing viscous sauces or syrups like chocolate syrup.

| | | Grams | % |
|---|---|---|---|
| Medium Intensity | Liquid Allulose | 112.77 | 36% |
| Sweetener | | | |
| Soluble Fiber | Liquid corn Fiber | 118.705 | 38% |
| High Intensity | Monk fruit | 0.03 | 0.01% |
| Sweetener | | | |
| Water | Water | 83.094 | 26% |
| Total | | 314.599 | 100.0% |

The sweetener formulation can be enhanced by performing optional modifications to the formulation and/or process of production as described in previous example 7. For example, one alternative includes adding salt as flavor modifier (e.g., 0.6 gm). Preparation can include cooking to 214 to 220 degrees F. The high intensity sweetener may be added after the preparation cools to below 200 degrees F. The flavors may be added after the preparation cools to below 200 degrees F.

### Example 23

### Preparation of Sweetener-XXII

The sweetener composition has favorable properties for producing jam orange marmalade. The sweetener composition provides a semi-solid jam Like Consistency that is not brittle to the end product upon baking. Hence it is ideal for making jams, jellies and marmalades.

Approximate formulation:

| | | Grams | % |
|---|---|---|---|
| Medium Intensity | Liquid Allulose | 190 | 44% |
| Sweetener | | | |
| Soluble Fiber | Agar Agar | 1.75 | 0% |
| Soluble Fiber | Pectin | 3 | 1% |
| Soluble Fiber | Liquid corn Fiber | 230 | 53% |
| High Intensity | Monk fruit | 0.03 | 0.01% |
| Sweetener | | | |
| Water | Water | 10 | 2% |
| Total | | 434.78 | 100.0% |

The sweetener formulation can be enhanced by performing optional modifications to the formulation and/or process of production as described in previous example 7. For example, one alternative includes adding salt as flavor modifier (e.g., 0.25 gm). Preparation may include cooking the mixture to until 214 to 220 degrees F. The high intensity sweetener may be added after the preparation cools to below 200 degrees F. Additionally or alternatively, flavors may be added after the preparation cools to below 200 degrees F. Additionally, or alternatively, the agar agar and pectin may be added after the preparation cools to below 200 degrees F. Additionally, or alternatively, dispersed bits (e.g. lemon rind, seeds) may be kept in uniform suspension as the mixture cools and liquid solidifies by filling into a container and rotating the container continuously or periodically.

Process Modifications

The following are some exemplary process modifications that can achieve favorable stickiness when the sugar substitute is used as a binder (e.g. in bars, granola, bakery items, etc.). Specifically, with any of the listed formulas, the dry blend is mixed with 50-200% water by weight and allowed to sit at least 15 minutes before combining with the other materials. In one exemplary embodiment, the water temperature initially may be above 110 degrees F. and may be maintained above 110 degrees F. during the hydration period. In another exemplary embodiment, the water temperature initially may be above 150 degrees F. and may be maintained above 150 degrees F. during the hydration period. In another exemplary embodiment, the water temperature initially may be above 175 degrees F. and may be maintained above 175 degrees F. during the hydration period. In another exemplary embodiment, the water temperature initially may be above 200 degrees F. and may be maintained above 200 degrees F. during the hydration period.

### Other Embodiments

The instant invention has been shown and described herein in what is considered to be the most practical and preferred embodiment. It is recognized, however, that departures may be made therefrom within the scope of the invention and that obvious modifications will occur to a person skilled in the art.

From the foregoing description, it will be apparent that variations and modifications may be made to the invention described herein to adopt it to various usages and conditions, including the use of different amounts or ratios or percentages of individual components such as medium intensity sweetener, high intensity sweetener or soluble fiber or flavor modifier. Recitation of a listing of elements in any definition of a variable herein includes definitions of that variable as any single element or combination (or sub combination) of listed elements. Recitation of an embodiment herein includes that embodiment as any single embodiment or in combination with any other embodiments or portions thereof.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

Various embodiments of the present invention may be characterized by the potential claims listed in the paragraphs following this paragraph (and before the actual claims provided at the end of the application). These potential claims form a part of the written description of the application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public. Nor are these potential claims intended to limit various pursued claims. Without limitation, potential subject matter that may be claimed (prefaced with the letter “P” so as to avoid confusion with the actual claims presented below) includes:

P1. A ketogenic sweetener composition comprising one or more medium intensity sweetener, one or more high intensity sweetener, and one or more soluble fiber.

P2. The composition of claim P1 further comprising one or more flavor modifier.

P3. The composition of claim P1 or P2, wherein the one or more medium intensity sweetener includes at least one sugar alcohol and/or at least one rare sugar.

P4. The composition of claim P3, wherein the at least one sugar alcohol includes at least one of mannitol, sorbitol, xylitol, lactitol, isomaltose, erythritol, maltitol, or hydrogenated starch hydrolysates (HSH).

P5. The composition of claim P3, wherein the at least one rare sugar includes at least one of allulose, allose, psicose, tagatose, or melezitose.

P6. The composition of claim P1 or P2, wherein the one or more high intensity sweetener includes at least one of monk fruit extract, stevia extract, sucralose, neotame, aspartame, advantame, thaumatin, or acesulfame potassium.

P7. The composition of claim P1 or P2, wherein the one or more soluble fiber includes at least one of soluble corn fiber, xanthum gum, guar gum, agar, soluble tapioca fiber, digestion resistant dextrin, digestion resistant maltodextrin, inulin, chicory root extract, polydextrose, fructo-oligosaccharide, isomalto-oligosaccharide, galacto-oligosaccharide, or xylo-oligosaccharide.

P8. The composition of any one of claims P2-P7, wherein the flavor modifier is selected from the group consisting of vanilla extract, cinnamon extract, and bitter blocker.

P9. The composition of any one of the above potential claims, wherein the soluble fiber is at an amount that is equal to or greater than the amount of medium intensity sweetener.

P10. The composition of any one of the above potential claims, wherein the medium intensity sweetener and the soluble fiber are present at a weight ratio of 1:1.

P11. The composition of any one of the above potential claims, wherein the medium intensity sweetener is less than 50% mass percent of the composition.

P12. The composition of any one of the above potential claims, wherein the soluble fiber is greater than 50% mass percent of the composition.

P13. The composition of any one of the above potential claims, wherein the high intensity sweetener is less than 0.5% mass percent of the composition.

P14. The composition of any one of the above potential claims, wherein the soluble fiber is between 50-55% mass percent of the composition.

P15. The composition of claim P14, wherein the medium intensity sweetener is between 50-55% mass percent of the composition.

P16. The composition of claim P15, wherein the high intensity sweetener is between mass percent of the composition.

P17. The composition of claim P16, wherein the soluble fiber consists of digestion resistant maltodextrin and inulin.

P18. The composition of claim P17, wherein the medium intensity sweetener is erythritol.

P19. The composition of claim P18, wherein the high intensity sweetener is monk fruit extract.

P20. The composition of any one of the above potential claims, wherein the ketogenic sugar composition has a taste, texture, mouth feel and visual appearance of common sugar, and is capable of serving as a weight and/or volume equivalent replacement of common sugar in baking recipes, bakery products and dietary food products.

P21. The composition of claim P3, wherein the sugar alcohols comprise at least one of mannitol, sorbitol, xylitol, lactitol, isomaltose, erythritol, maltitol, or hydrogenated starch hydrolysates (HSH) and the rare sugars comprise at least one of allulose, allose, psicose, tagatose, or melezitose.

P22. The composition of any one of the above potential claims, wherein the high intensity sweetener comprises at least two of monk fruit extract, stevia extract, sucralose, neotame, aspartame, advantame, thaumatin or acesulfame potassium.

P23. The composition of any one of the above potential claims, wherein the soluble fiber comprises at least two of soluble corn fiber, xanthum gum, guar gum, agar, soluble tapioca fiber, digestion resistant dextrin, digestion resistant maltodextrin, inulin, chicory root extract, polydextrose, fructo-oligosaccharide, isomalto-oligosaccharide, galacto-oligosaccharide, or xylo-oligosaccharide.

P24. The composition of any one of the above potential claims, wherein the percentage of medium intensity sweetener to the percentage of the soluble fiber is selected from the group consisting of 20/80, 25/75, 30/70, 40/60, 55/45, 50/50, and 45/55.

P25. The composition of claim P1, wherein the composition is selected from the group consisting of sweetener-I, sweetener-II, sweetener-III, sweetener-IV, sweetener-V, sweetener-VI, sweetener-VII, sweetener-VIII, sweetener-IX, sweetener-X, sweetener-XI, sweetener-XII, sweetener-XIII, sweetener-XIV, sweetener-XV, sweetener-XVI, sweetener-XVII, sweetener-XVIII, sweetener-XIX, sweetener-XX, sweetener-XXI, and sweetener-XXII.

P26. A method of producing the composition of any one of the above potential claims, wherein the amount of soluble fiber is adjusted to ensure good digestive tolerance and low glycemic index with a taste profile similar to raw sugar.

Other embodiments are within the following claims.

1. A composition comprising one or more medium intensity sweetener, one or more high intensity sweetener, and one or more soluble fiber, wherein the soluble fiber is at an amount that is equal to or greater than the amount of medium intensity sweetener, the ratio of medium intensity sweetener to soluble fiber is above around 0.8, and said composition has a taste, texture, mouth feel and visual appearance of common sugar.

2. The composition of claim 1, wherein the one or more medium intensity sweetener includes at least one sugar alcohol and/or at least one rare sugar.

3. The composition of claim 2, wherein the at least one sugar alcohol includes at least one of mannitol, sorbitol, xylitol, lactitol, isomaltose, erythritol, maltitol, or hydrogenated starch hydrolysates.

4. The composition of claim 2, wherein the at least one rare sugar includes at least one of allulose, allose, psicose, tagatose, or melezitose.

5. (canceled)

6. The composition of claim 1, wherein the one or more high intensity sweetener comprises at least one of monk fruit extract, stevia extract, sucralose, neotame, aspartame, advantame, thaumatin, or acesulfame potassium.

7. The composition of claim 1, wherein the one or more high intensity sweetener comprises at least two of monk fruit extract, stevia extract, sucralose, neotame, aspartame, advantame, thaumatin, or acesulfame potassium.

8. The composition of claim 1, wherein the one or more soluble fiber comprises at least one of soluble corn fiber, xanthum gum, guar gum, agar, soluble tapioca fiber, digestion resistant dextrin, digestion resistant maltodextrin, inulin, chicory root extract, polydextrose, fructo-oligosaccharide, isomalto-oligosaccharide, galacto-oligosaccharide, or xylo-oligosaccharide.

9. The composition of claim 1, wherein the one or more soluble fiber comprises at least two of soluble corn fiber, xanthum gum, guar gum, agar, soluble tapioca fiber, digestion resistant dextrin, digestion resistant maltodextrin, inulin, chicory root extract, polydextrose, fructo-oligosaccharide, isomalto-oligosaccharide, galacto-oligosaccharide, or xylo-oligosaccharide.

10. The composition of claim 1 further comprising one or more flavor modifier.

11. The composition of claim 10, wherein the one or more flavor modifier is selected from the group consisting of vanilla extract, cinnamon extract, and bitter blocker.

12. (canceled)

13. (canceled)

14. (canceled)

15. The composition of claim 1, wherein the soluble fiber is greater than 50% mass percent of the composition.

16. The composition of claim 1, wherein the high intensity sweetener is less than 0.5% mass percent of the composition.

17. The composition of claim 1, wherein the soluble fiber is between 50-55% mass percent of the composition.

18. (canceled)

19. The composition of claim 17, wherein the high intensity sweetener is between 0.1-0.5% mass percent of the composition.

20. The composition of claim 19, wherein the soluble fiber consists of digestion resistant maltodextrin and inulin.

21. The composition of claim 20, wherein the medium intensity sweetener is erythritol.

22. The composition of claim 21, wherein the high intensity sweetener is monk fruit extract.

23. (canceled)

24. The composition of claim 1, wherein said composition is capable of serving as a weight and/or volume equivalent replacement of common sugar in baking recipes, bakery products and dietary food products.

25. (canceled)

26. (canceled)

27. A method of producing a composition, the method comprising: combining one or more medium intensity sweetener, one or more high intensity sweetener, and one or more soluble fiber to produce the composition, wherein the soluble fiber is at an amount that is equal to or greater than the amount of medium intensity sweetener, wherein said composition has a taste, texture, mouth feel and visual appearance of common sugar.
